(19) United States
(12) Patent Application Publication
(10) Pub. No.: US 2009/0147006 A1
(43) Pub. Date: Jun. 11, 2009

(54) Method and system for event based data comparison

(75) Inventors: Schuyler Buck, Muncie, IN (US); Morris J. Young, Indianapolis, IN (US)

Correspondence Address: BAKER & DANIELS LLP / ROCHE, 300 NORTH MERIDIAN STREET, SUITE 2700, INDIANAPOLIS, IN, 46204, US

(73) Assignee: Roche Diagnostics Operations, Inc., Indianapolis, IN (US)

(21) Appl. No.: 11/999,921

(22) Filed: Dec. 7, 2007

(51) Int. Cl. G06T 11/20

(52) U.S. Cl. 345/440.2; 345/440

(57) ABSTRACT

A method of displaying medical data for at least one patient allows the data to be displayed in graphical format as either a trend graph or a histogram. The data may be sorted based upon a selected event. The trend graph may include a line representing the event, and the data on the graph may be plotted on the graph for specific periods before and after the event. When the data is displayed as a histogram, the data prior to the event is represented by one type of bars, and the data after the event is represented by another type of bars. The selected event, and the type of data displayed on the graph may be altered.

### FIELD OF THE INVENTION

The present invention relates to presenting data in graphical format utilizing computer software. Specifically, the present invention relates to medical software capable of presenting medical data of a patient to a health care provider in graphical format in a manner allowing the user to evaluate the data relative to a specific event.

### BACKGROUND OF THE INVENTION

Software for monitoring medical information for a patient is known. For example, prior art software is capable of compiling blood glucose and other similar measurements for a patient with diabetes. The data gathered for each patient, in addition to the vital statistics associated with the patient, such as name, age, gender, etc., may be stored in a database. It is known to display certain medical data, such as blood glucose measurements, to a health care provider in graphical format.

### SUMMARY OF THE INVENTION

An embodiment of the invention comprises a method of presenting a set of data on a display including a graph. The method may comprise the steps of selecting an event; dividing the set of data into a first subset of data that occurred prior to the event and a second subset of data that occurred after the event; plotting the first subset of data on the graph; and plotting the second subset of data on the graph in a manner distinguishing the second subset of data from the first subset of data.

The method may further comprise the step plotting an event indicator on the graph between the first subset of data and the second subset of data. The indicator may be a line.

In embodiments of the invention, the first subset of data and the second subset of data are plotted as a trend line. The method may further comprise the step of plotting a standard deviation indicator on the graph. The standard deviation indicator is a shaded area.

In embodiments of the invention, the method further comprises the steps of dividing a second set of data into a first subset of second data and a second subset of second data; plotting the first subset of second data on the graph; and plotting the second subset of second data on the graph. The method may further comprise the step of removing the first subset of data from the graph.

The first subset of data may be plotted as a first subset of bars, and the second subset of data may be plotted as a second subset of bars. The first subset of bars may be spaced apart from the second subset of bars. In embodiments of the invention, the first subset of bars are a first color, and the second subset of bars are a second color. The first color may differ from the second color. The data may represent a percentage of patients. The data may represent a percentage of results.

In embodiments of the invention, the set of data comprises blood glucose measurements of at least one patient over time.

Embodiments of the invention comprise a method of plotting a set of data on a graph in order to determine if an event affected the health of a patient. The method may comprise the steps of plotting the data on the graph; and plotting an indicator representing the event on the graph.

Embodiments of the invention comprise a method of plotting a set of data on a histogram. The method may comprise the steps of selecting an event; dividing the data into a first subset of data that occurred prior to the event and a second subset of data that occurred after the event; displaying the first subset of data as at least one bar of a first type; and displaying the second subset of data as at least one bar of a second type.

### BRIEF DESCRIPTION OF THE DRAWINGS

The above-mentioned and other features of this invention, and the manner of attaining them, will become more apparent and the invention itself will be better understood by reference to the following description of embodiments of the invention taken in conjunction with the accompanying drawings, wherein:

FIGS. 1 through 27 depict screen captures of a program embodying aspects of the present invention.

Although the drawings represent embodiments of various features and components according to the present invention, the drawings are not necessarily to scale and certain features may be exaggerated in order to better illustrate and explain the present invention. The exemplifications set out herein illustrate embodiments of the invention, and such exemplifications are not to be construed as limiting the scope of the invention in any manner.

### DETAILED DESCRIPTION OF EMBODIMENTS OF THE INVENTION

For the purposes of promoting an understanding of the principles of the invention, reference will now be made to the embodiments illustrated in the drawings, which are described below. It will nevertheless be understood that no limitation of the scope of the invention is thereby intended. The invention includes any alterations and further modifications in the illustrated devices and described methods and further applications of the principles of the invention, which would normally occur to one skilled in the art to which the invention relates. Moreover, the embodiments were selected for description to enable one of ordinary skill in the art to practice the invention.

Concepts described below may be further explained in one of more of the co-filed patent applications entitled HELP UTILITY FUNCTIONALITY AND ARCHITECTURE (Atty Docket: ROCHE-P0033), METHOD AND SYSTEM FOR GRAPHICALLY INDICATING MULTIPLE DATA VALUES (Atty Docket: ROCHE-P0039), SYSTEM AND METHOD FOR DATABASE INTEGRITY CHECKING (Atty Docket: ROCHE-P0056), METHOD AND SYSTEM FOR DATA SOURCE AND MODIFICATION TRACKING (Atty Docket: ROCHE-P0037), PATIENT-CENTRIC HEALTHCARE INFORMATION MAINTENANCE (Atty Docket: ROCHE-P0043), EXPORT FILE FORMAT WITH MANIFEST FOR ENHANCED DATA TRANSFER (Atty Docket: ROCHE-P0044), GRAPHIC ZOOM FUNCTIONALITY FOR A CUSTOM REPORT (Atty Docket: ROCHE-P0048), METHOD AND SYSTEM FOR SELECTIVE MERGING OF PATIENT DATA (Atty Docket: ROCHE-P0065), METHOD AND SYSTEM FOR PERSONAL MEDICAL DATA DATABASE MERGING (Atty Docket: ROCHE-P0066), METHOD AND SYSTEM FOR WIRELESS DEVICE COMMUNICATION (Atty Docket: ROCHE-P0034), METHOD AND SYSTEM FOR SETTING TIME BLOCKS (Atty Docket: ROCHE-P0054), METHOD AND SYSTEM FOR ENHANCED DATA TRANSFER (Atty Docket: ROCHE-P0042), COMMON EXTENSIBLE DATA EXCHANGE FORMAT (Atty Docket: ROCHE-P0036), METHOD OF CLONING SERVER INSTALLATION TO A NETWORK CLIENT (Atty Docket: ROCHE-P0035), METHOD AND SYSTEM FOR QUERYING A DATABASE (Atty Docket: ROCHE-P0049), DYNAMIC COMMUNICATION STACK (Atty Docket: ROCHE-P0051), SYSTEM AND METHOD FOR REPORTING MEDICAL INFORMATION (Atty Docket: ROCHE-P0045), METHOD AND SYSTEM FOR MERGING EXTENSIBLE DATA INTO A DATABASE USING GLOBALLY UNIQUE IDENTIFIERS (Atty Docket: ROCHE-P0052), METHOD AND SYSTEM FOR ACTIVATING FEATURES AND FUNCTIONS OF A CONSOLIDATED SOFTWARE APPLICATION (Atty Docket: ROCHE-P0057), METHOD AND SYSTEM FOR CONFIGURING A CONSOLIDATED SOFTWARE APPLICATION (Atty Docket: ROCHE-P0058), METHOD AND SYSTEM FOR DATA SELECTION AND DISPLAY (Atty Docket: ROCHE-P0011), METHOD AND SYSTEM FOR ASSOCIATING DATABASE CONTENT FOR SECURITY ENHANCEMENT (Atty Docket: ROCHE-P0041), METHOD AND SYSTEM FOR CREATING REPORTS (Atty Docket: ROCHE-P0046), METHOD AND SYSTEM FOR CREATING USER-DEFINED OUTPUTS (Atty Docket: ROCHE-P0047), DATA DRIVEN COMMUNICATION PROTOCOL GRAMMAR (Atty Docket: ROCHE-P0055), HEALTHCARE MANAGEMENT SYSTEM HAVING IMPROVED PRINTING OF DISPLAY SCREEN INFORMATION (Atty Docket: ROCHE-P0031), and METHOD AND SYSTEM FOR MULTI-DEVICE COMMUNICATION (Atty Docket: ROCHE-P0064), the entire disclosures of which are hereby expressly incorporated herein by reference. It should be understood that the concepts described below may relate to diabetes management software systems for tracking and analyzing health data, such as, for example, the ACCU-CHEK® 360° product provided by Roche Diagnostics. However, the concepts described herein may also have applicability to apparatuses, methods, systems, and software in fields that are unrelated to healthcare. Furthermore, it should be understood that references in this patent application to devices, meters, monitors, pumps, or related terms are intended to encompass any currently existing or later developed apparatus that includes some or all of the features attributed to the referred to apparatus, including but not limited to the ACCU-CHEK® Active, ACCU-CHEK® Aviva, ACCU-CHEK® Compact, ACCU-CHEK® Compact Plus, ACCU-CHEK® Integra, ACCU-CHEK® Go, ACCU-CHEK® Performa, ACCU-CHEK® Spirit, ACCU-CHEK® D-Tron Plus, and ACCU-CHEK® Voicemate Plus, all provided by Roche Diagnostics or divisions thereof.

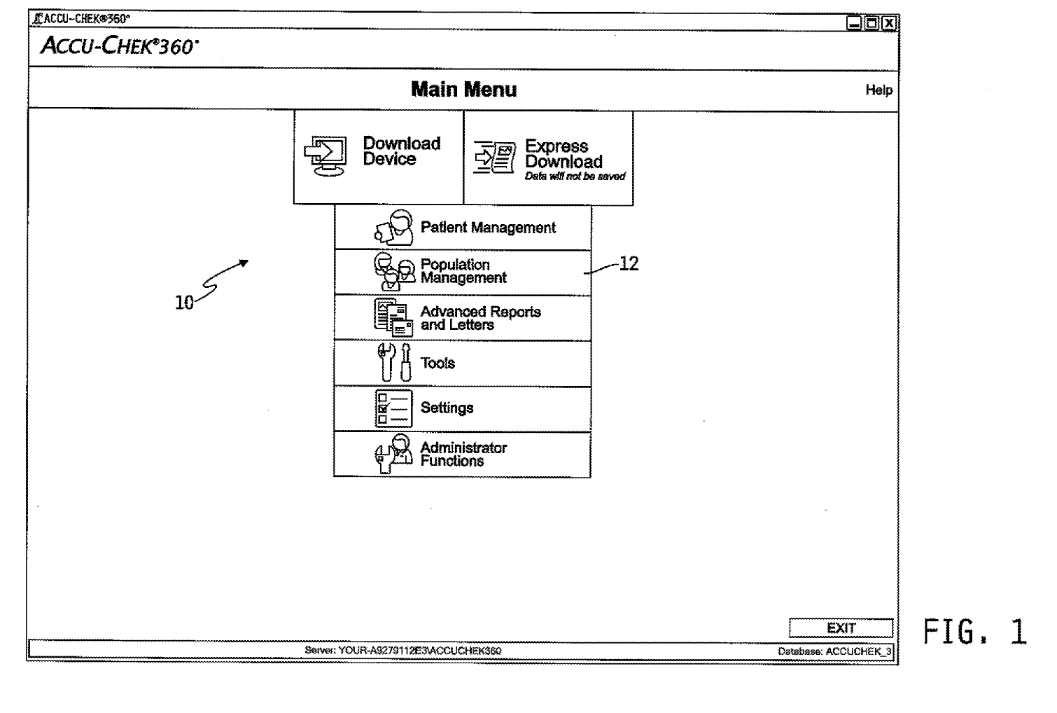

FIG. 1 depicts a screen capture from software entitled ACCU-CHEK® 360° from Roche Diagnostics, representing an embodiment of the present invention. The ACCU-CHEK® 360° software may be utilized on any suitable processor, such as a computer, cell phone, personal data assistant, etc. The present embodiment of the invention relates to medical software utilized in the care of a patient with diabetes. It should be noted that the invention itself is not limited to medical software, but may be utilized in any suitable software program.

The present software is configured for use with a database containing information on a plurality of patients. Generally, for each patient, the database includes personal information such as the patient's name, birth date, gender, etc., along with medical information such as the type of diabetes that the patient has, blood glucose measurements associated with the patient over time, the type of insulin utilized by the patient, etc. Other exemplary medical information includes A1c values, Albumin values, Albumin excretion values, body mass index values, blood pressure values, carbohydrate values, cholesterol values (total, HDL, LDL, ratio) creatinine values, fructosamine values, HbA1 values, height values, insulin dose values, insulin rate values, total daily insulin values, ketone values, microalbumin values, proteinuria values, heart rate values, temperature values, triglyceride values, and weight values. Furthermore, the information for each patient may be linked to the other stored information for a given patient in any suitable manner.

With reference still to FIG. 1, numeral 10 generally indicates a main menu. Main menu 10 includes a plurality of menu options, including a population management icon 12. In the present example, population management allows a user to structure a search in order to locate patients within the database that satisfy a specific search criteria. The patients meeting the search criteria may be saved as a group for later reference. Population management icon 12 may be selected in any suitable manner, such as by utilizing a mouse to control a cursor in order to click the population management icon 12.

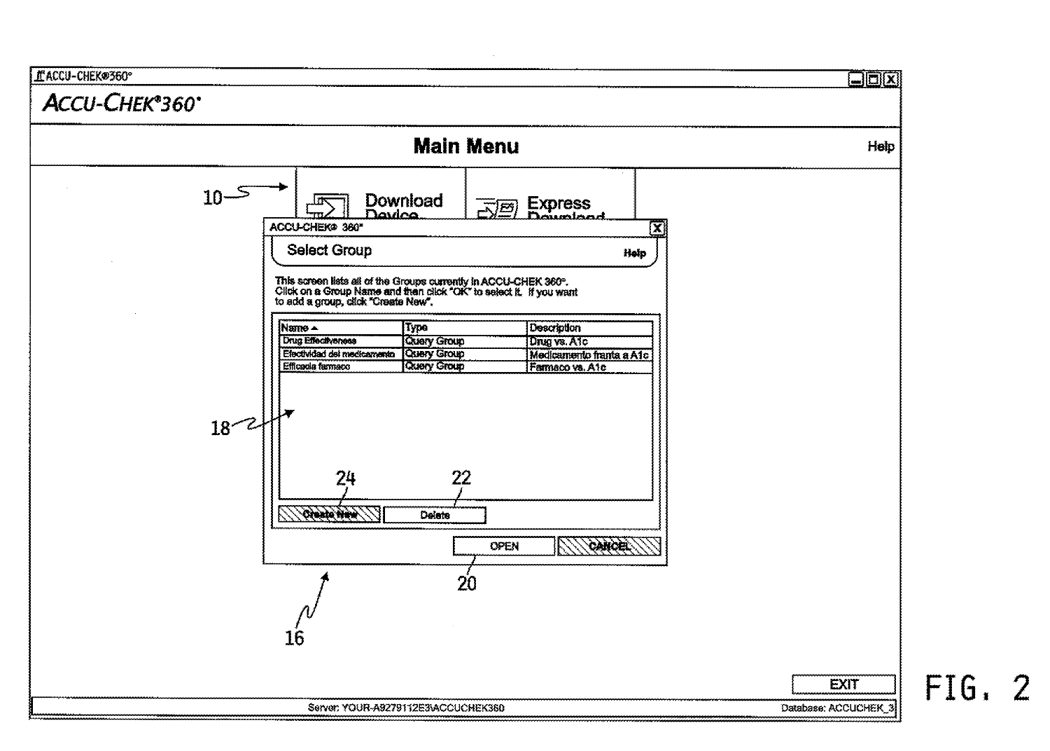

As shown in FIG. 2, clicking the population management icon 12 causes an interface box, indicated by numeral 16, to open. Interface box 16 may include a listing of groups, generally indicated by numeral 18, an open icon 20, a delete icon 22 and create new icon 24. The group listing 18 displays all groups previously created by the user. If the user desires to open one of the previous group listings 18, the user may do so in any conventional manner. For example, the user may double click the group that the user desires to open, or the user may click the group that the user would like to open to highlight it and then click the open icon 20. The user may also delete a group by selecting the group and then actuating the delete icon 22.

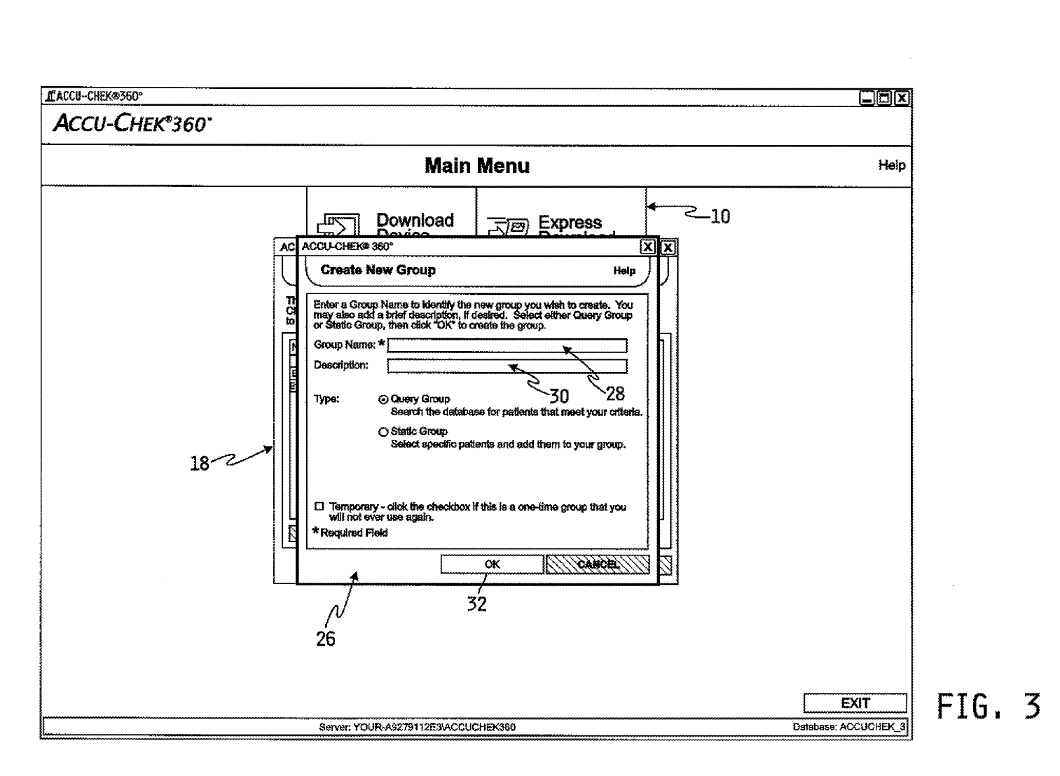

Referring still to FIG. 2, if the user would like to create a custom group, the user may click the create new icon 24. As shown in FIG. 3, once the user clicks the create new icon 24, a create new group interface box, indicated by numeral 26, is displayed. In interface box 26, numeral 28 indicates a box in which the user may enter a group name, and numeral 30 indicates a box in which the user may enter a description of the group. Once the user has entered a group name in box 28 and a description in box 30, the user may actuate the OK icon 32 in a suitable manner, such as by clicking, for example.

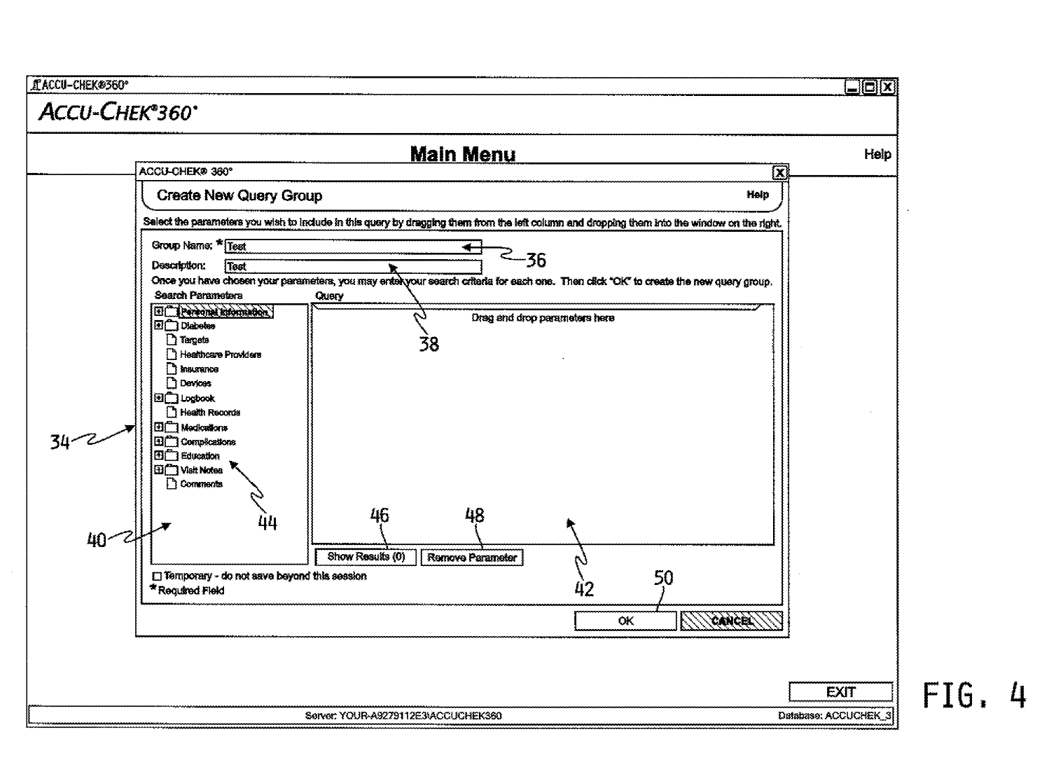

Upon actuating the OK icon 32, the software presents the user with a create new query group interface box 34, as shown in FIG. 4. In the present embodiment, box 34 includes a box 36 displaying the group name, a box 38 displaying the group description, a search parameter menu, indicated by numeral 40, and a query box, indicated by numeral 42.

In the depicted embodiment, search parameter menu 40 includes a list of search parameters, generally indicated by numeral 44. The list of search parameters 44 may include any desired data information that may be associated with the patients. For example, the search parameters may include personal information, such as name, birth date, age, gender, etc. and diabetes information, such as diabetes type, diagnosis date, insulin start date, etc. along with various other type of information.

Referring still to FIG. 4, in the depicted embodiment, group interface box 34 further includes a show results icon 46 and a remove parameter icon 48. In addition, the group interface box 34 further includes an OK icon 50.

With reference still to FIG. 4, the user may elect to search any of the criteria comprising list 44. For example, the user may select the age of the patients as the search criteria.

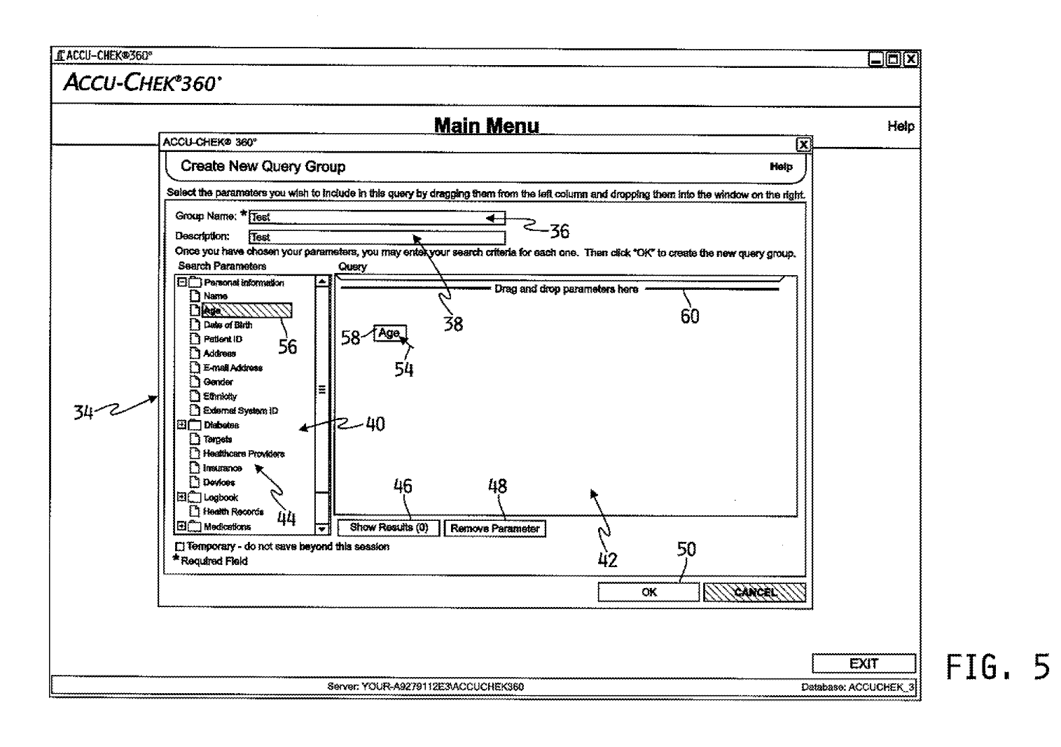

With reference now to FIG. 5, in the present embodiment, in order to construct the search, the user may move the cursor 54 to the age parameter 56 of the list of search parameters 44. The user may then click the age parameter 56 and begin dragging the age parameter 56. Once the cursor 54 crosses from the search parameter menu 40 into the query box 42, an icon 58 that includes text, indicating the type of file being dragged, appears. For example, in the depicted embodiment, icon 58 includes text reading “Age,” since the age parameter 56 has been selected and dragged by the user into the query box 42. In addition, once the icon 58 appears in the query box 42, an indicator line 60 also appears. It should be noted that in the depicted embodiment, indicator line 60 extends across substantially the entire width of query box 42. In addition, indicator line 60 may be a given color, such as blue, for example.

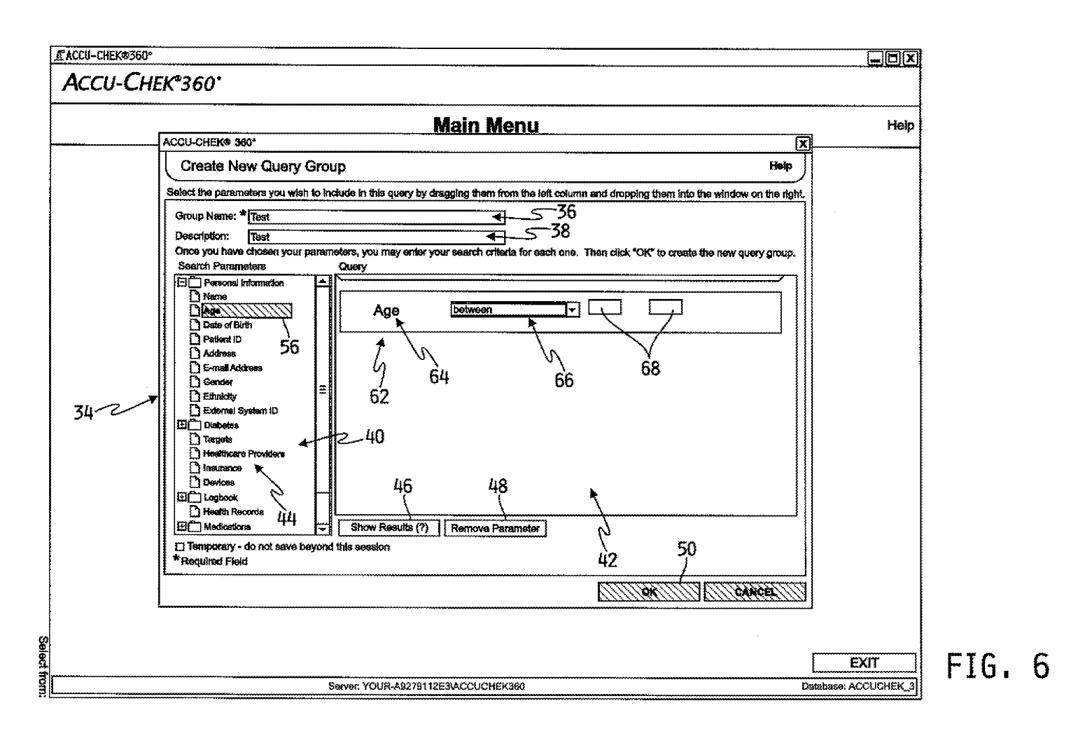

As shown in FIG. 6, once the user drops, or releases the icon 58 in query box 42, a first search box, indicated by numeral 62, appears. First search box 62 includes a title 64 indicating the search parameter to be searched. In the present example, the title 64 reads “Age,” since the user dragged the age search criteria from the search parameters menu 40.

As shown in FIG. 6, the search box 62 includes a drop down menu 66 and two information entering boxes, each indicated by numeral 68. As can be seen from FIG. 6, search box 62 defaults into allowing a user to search for patients having an age that falls within the range specified in the information boxes 68.

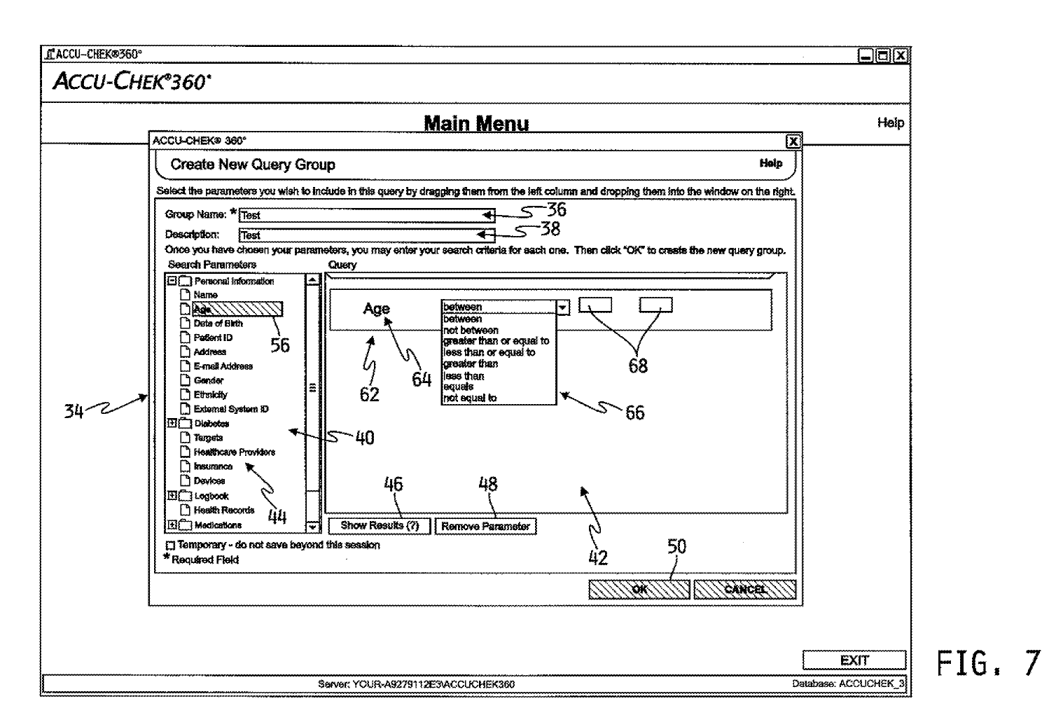

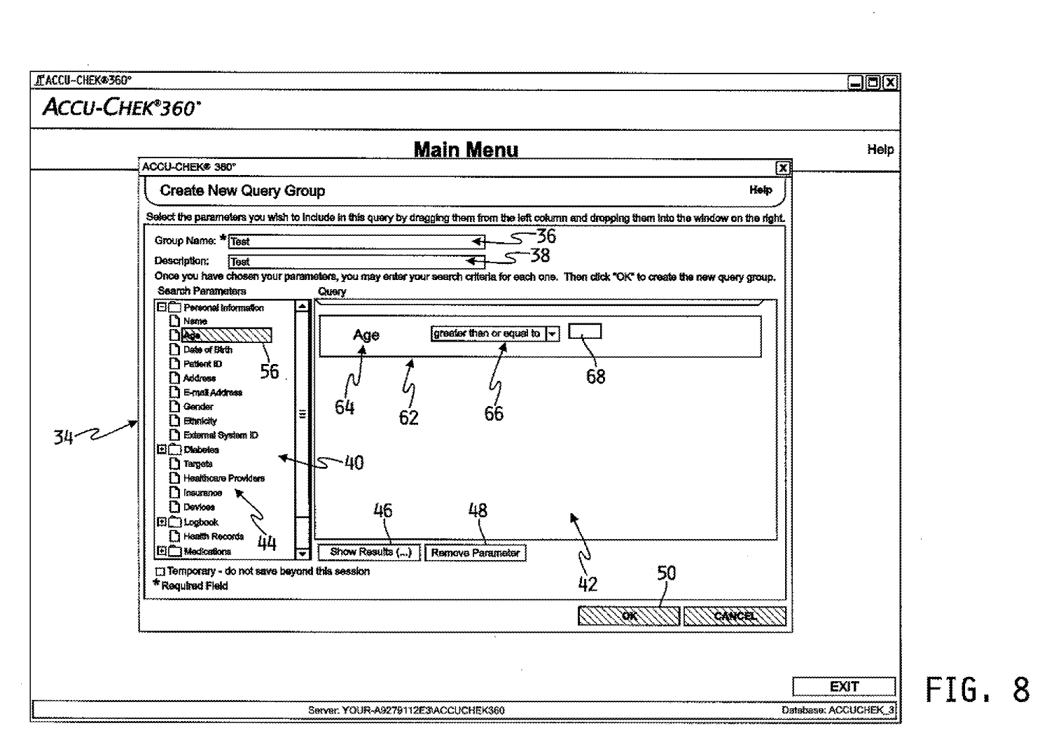

With reference now to FIG. 7, the user may expand the drop down menu 66 in any suitable manner. For example, the user may click the menu 66 in order to expand the menu and allow the user to select different search criteria. In the depicted example, the user may select various criteria for an age search, such as an age range “not between” two numbers, an age “greater than” a number, an age “less than” a number, etc. FIG. 8 provides a screen capture depicting the search box 62 after the search criteria “greater than or equal to” has been selected in the drop down menu 66.

As shown in FIG. 8, the number of information input boxes 68 has been altered in accordance with the search criteria selected, since the selected search criteria only requires one search parameter to be entered. As shown previously, when appropriate, box 62 may include a plurality of boxes 68 in accordance with the criteria selected in menu 68. Once a search criteria has been selected with menu 66 and entered into box 68, the show results icon 46 may be actuated in any conventional manner. For example, the user may move the cursor over the icon 46 and click the icon 46 using a mouse.

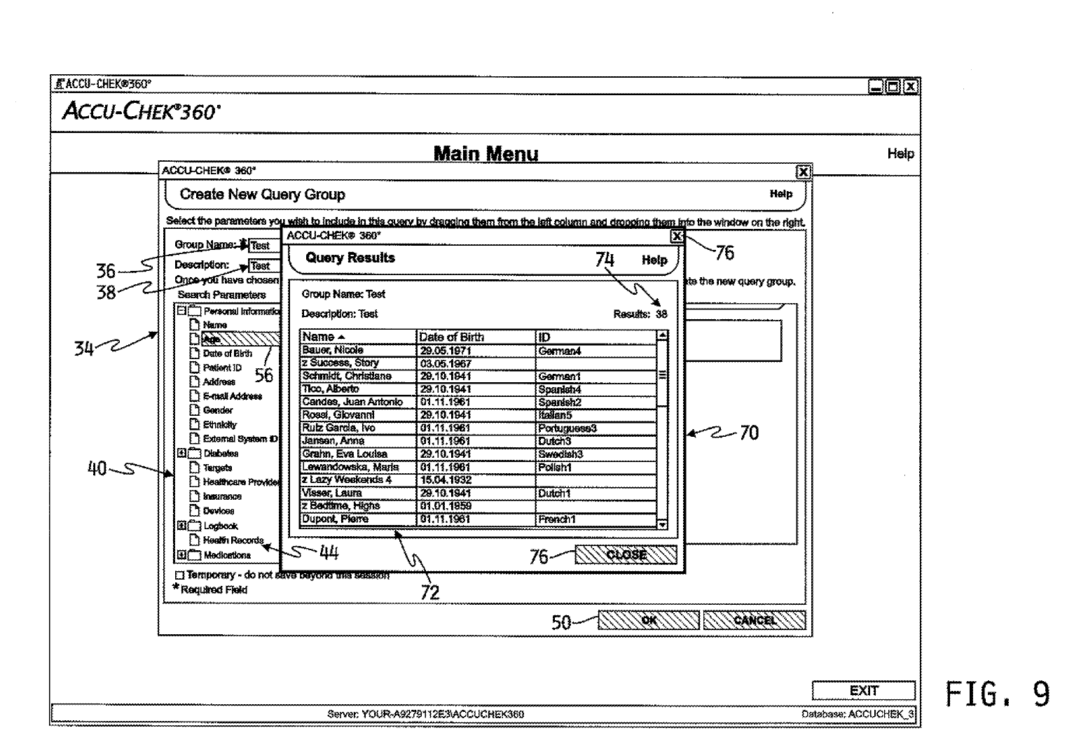

As shown in FIG. 9, upon activating the show results icon 46, the user is shown a results box, generally indicated by numeral 70. The results box 70 includes a list of patients, indicated by numeral 72, meeting the specified search criteria. In addition, box 70 includes a display 74 of the total number of patients meeting the search criteria and included in the list 72. In the current example, 38 patients meet the selected search criteria. Box 70 further includes a close icon 76 capable of closing the box 70 when actuated.

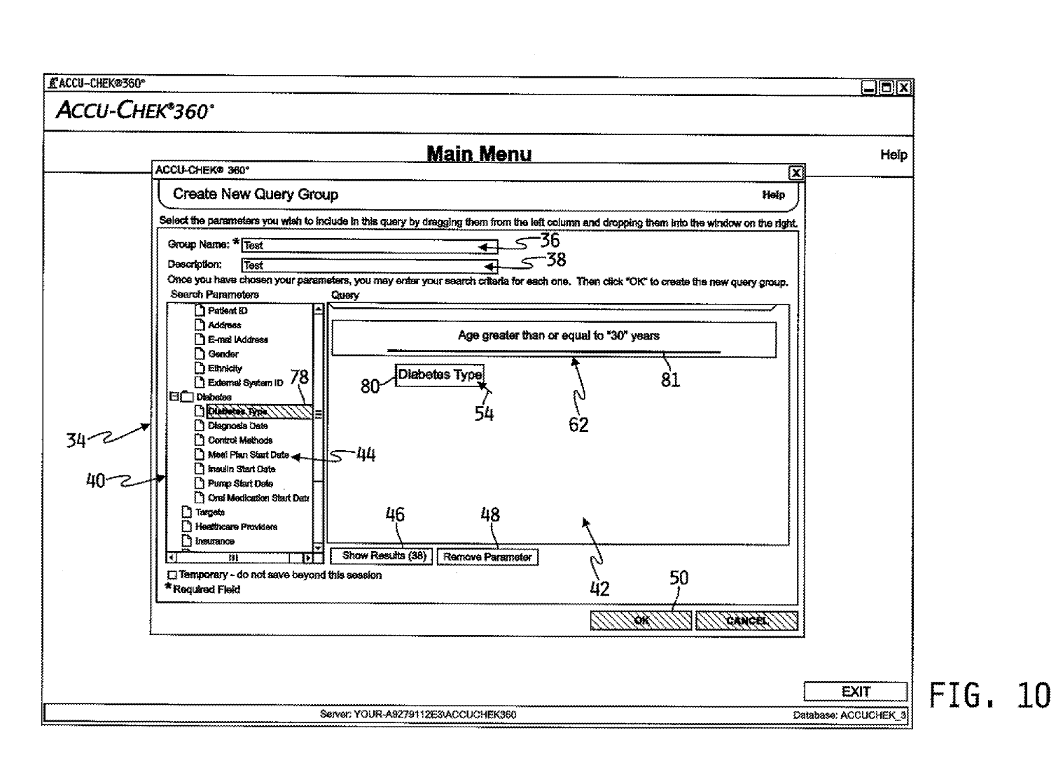

With reference now to FIG. 10, the user may further narrow the search criteria of the group by selecting additional search parameters from the list 44. For example, the user may select diabetes type icon 78 from list 44. In a manner similar to that described above, the user may click and drag the diabetes type icon 78 from the search parameters menu 40 into the query box 42. Again, once the cursor 54 enters the query box 42, an icon 80 displaying “diabetes type” will appear in the query box 42. Similarly, line 81 also appears. It should be noted that the line 81 differs in size from the line 60 shown in FIG. 5, and in embodiments of the invention, line 81 may also differ in color from line 60. It should further be noted that the selection of additional search parameters from list 44 may be accomplished without first selecting the show results icon 46.

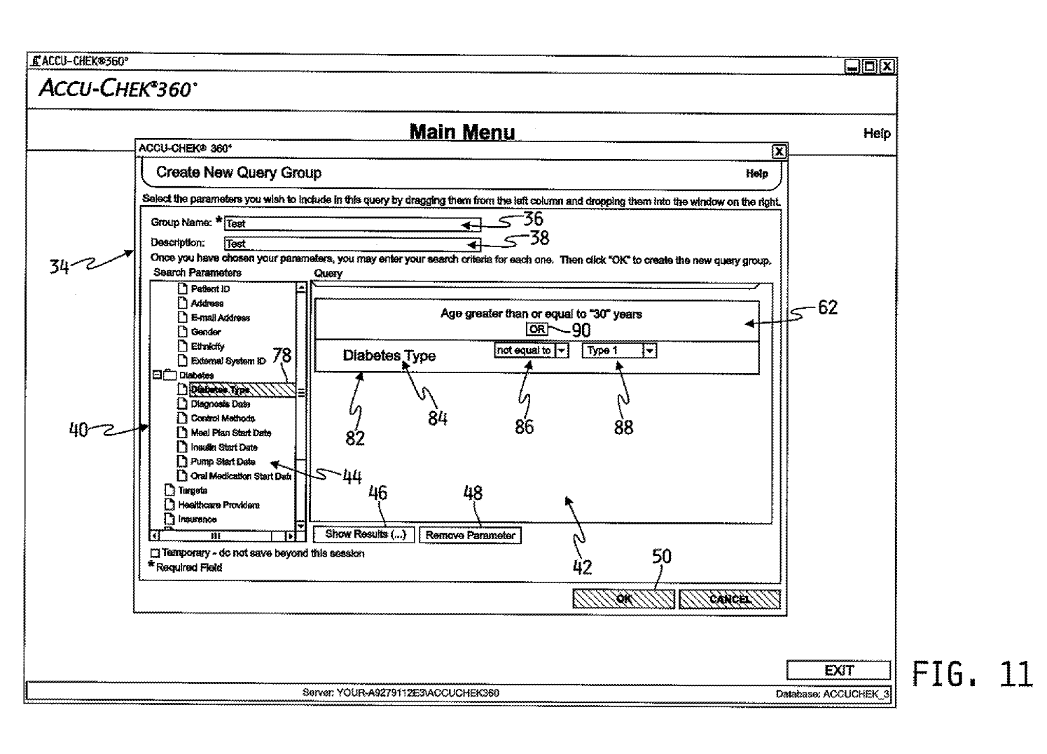

As shown in FIG. 11, once the icon 80 is released, a diabetes type query box 82 appears in the query box 42. Box 82 includes a title 84 indicating the search criteria of box 82 and drop down menus 86, 88. The drop down menus 86, 88 may be utilized to indicate the search criteria for the box 82. In the depicted embodiment, drop down menu 86 provides the operation for the search and menu 88 provides the criteria of the search. For example, drop down menu 86 is set to “not equal to,” and drop down menu 88 is set to “Type 1.” Accordingly, box 82 is configured to exclude from the search results all patients in the database who have Type 1 diabetes.

With reference still to FIG. 11, query box 42 includes a Boolean operation indicator 90. In the present embodiment, the Boolean indicator 90 is an “OR” operation. Accordingly, the search operation depicted in query box 42 is configured to find all of the patients in the database that satisfy at least one of the search parameters. For example, any patient that is at least 30 years old or does not have Type 1 diabetes will satisfy the search criteria. In a manner similar to that described above, the health care service user can display the patients satisfying the search criteria by actuating the show results icon 46.

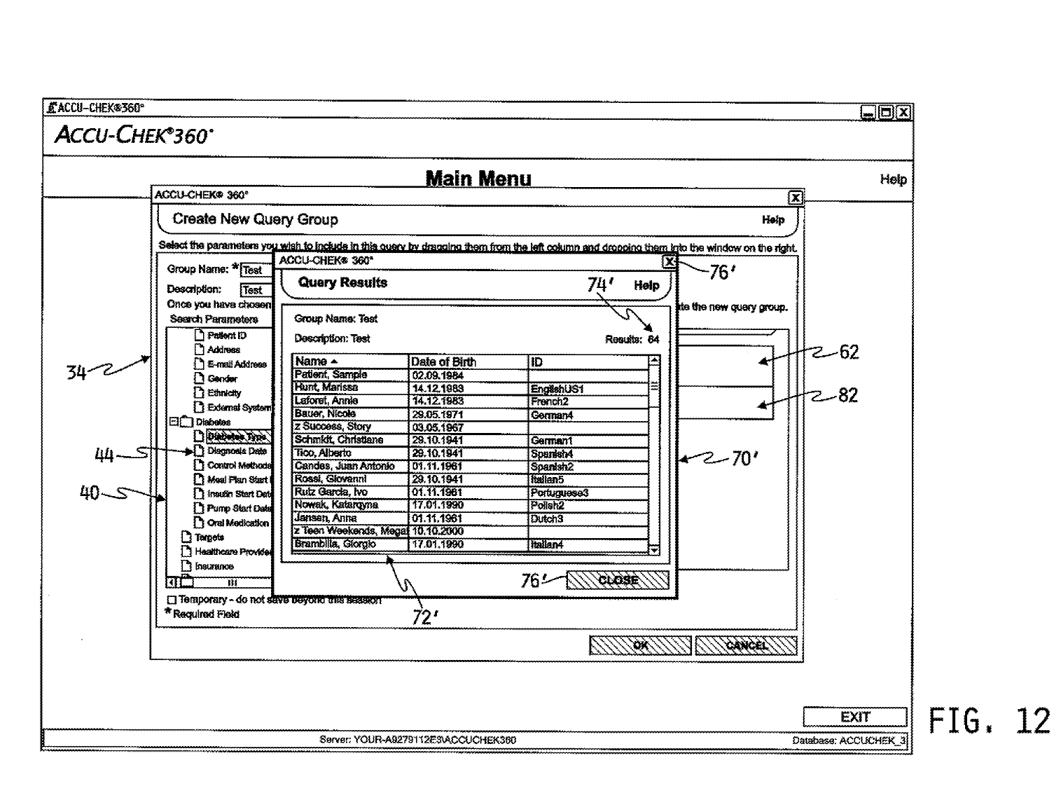

Actuation of the show results icon 46 causes, as shown in FIG. 12, a query results box 70′ to be displayed. Box 70′ includes a list 72′ of patients meeting the search criteria. As shown at 74′, the current search found 64 patients satisfying at least one of the two search criteria.

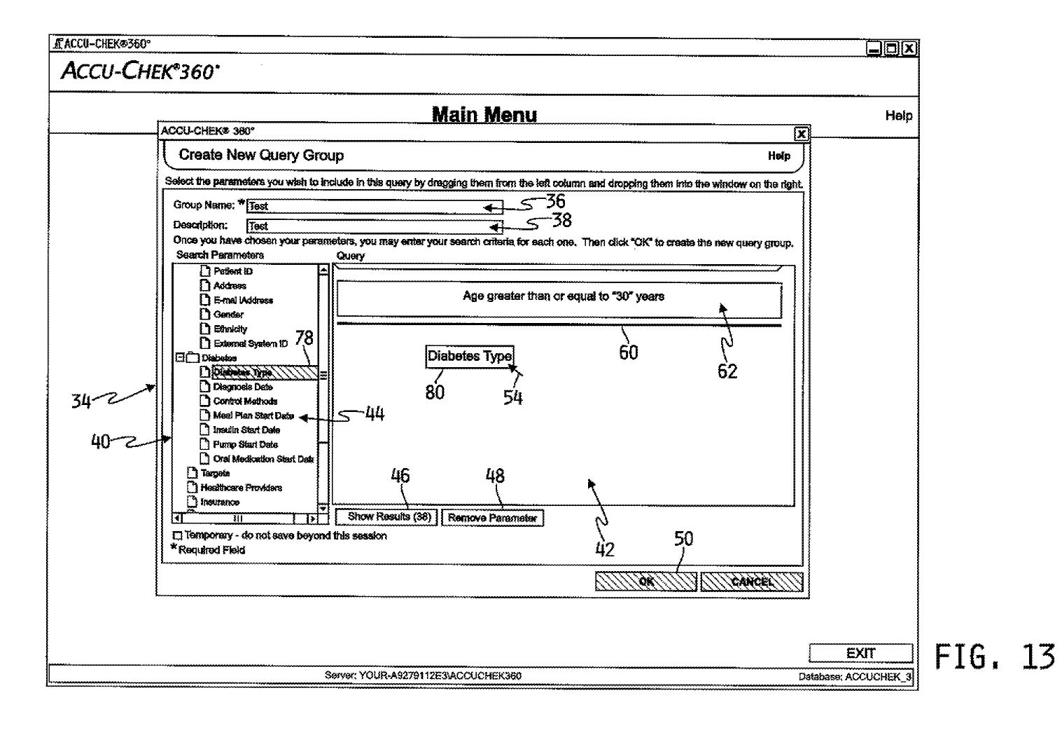

FIG. 13 depicts a screen capture illustrating the manner in which the two example search criteria may be connected using an “AND” Boolean operator. As shown in FIG. 13, in order to connect the search parameters with an “AND” operator, the icon 80 is dragged into the query box 42 at a position further below the position of box 62 depicted in FIG. 10. It should be noted that in FIG. 13, line 60 extends substantially across the entirety of the query box 62, and line 60 is much longer in length than line 81 (FIG. 10). In embodiments, line 60 may also be of a different color than line 81 (FIG. 10). It should be noted that line 81 indicates an “AND” Boolean function will connect the search parameters, and line 60 indicates an “OR” Boolean function will connect the search parameters. Thus, as the user is dragging the icon 80, the user may move icon 80 vertically within box 42 until the line 60, 81 corresponding to the desired Boolean operator appears.

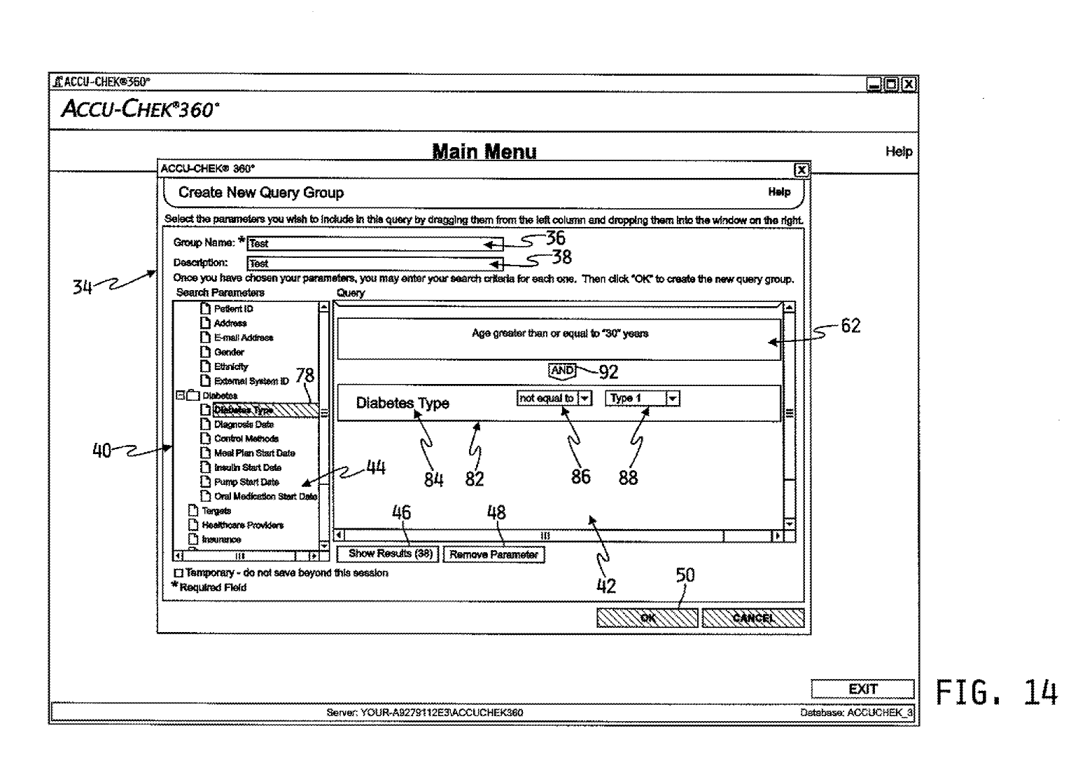

Upon releasing the icon 80, the user is presented with the screen capture depicted in FIG. 14, and query box 42 now includes a Boolean operation AND, indicated by numeral 92. Thus, the search depicted in FIG. 14, will only find patients in the database that are at least 30 years old and do not have Type 1 diabetes. It should be noted that the show results icon 46 now reads “38.” In the depicted embodiment of the invention, the show results icon 46 automatically updates to in order to inform the user of the number of patients satisfying the search requirements. The user may actuate the show results icon 46 in a suitable manner, as described above, if the user desires to view the patients satisfying the search requirements.

By continuing to drag and drop search parameters 44 from search parameter menu 40 into query box 42, the user may construct a search comprising any number of search parameters. In addition, the search constructed by the user may include any number of Boolean connectors. By positioning the search boxes in a manner similar to that described above, the user may arrange for various Boolean operations connecting the various search parameters.

If the user desires to remove one of the search parameters, the user may click one of the boxes 62, 81 and then actuate the remove a parameter icon 48, in a suitable manner. Furthermore, if the user is satisfied with the search, the user may actuate the OK icon 50 in order to save the group of patients meeting the search criteria.

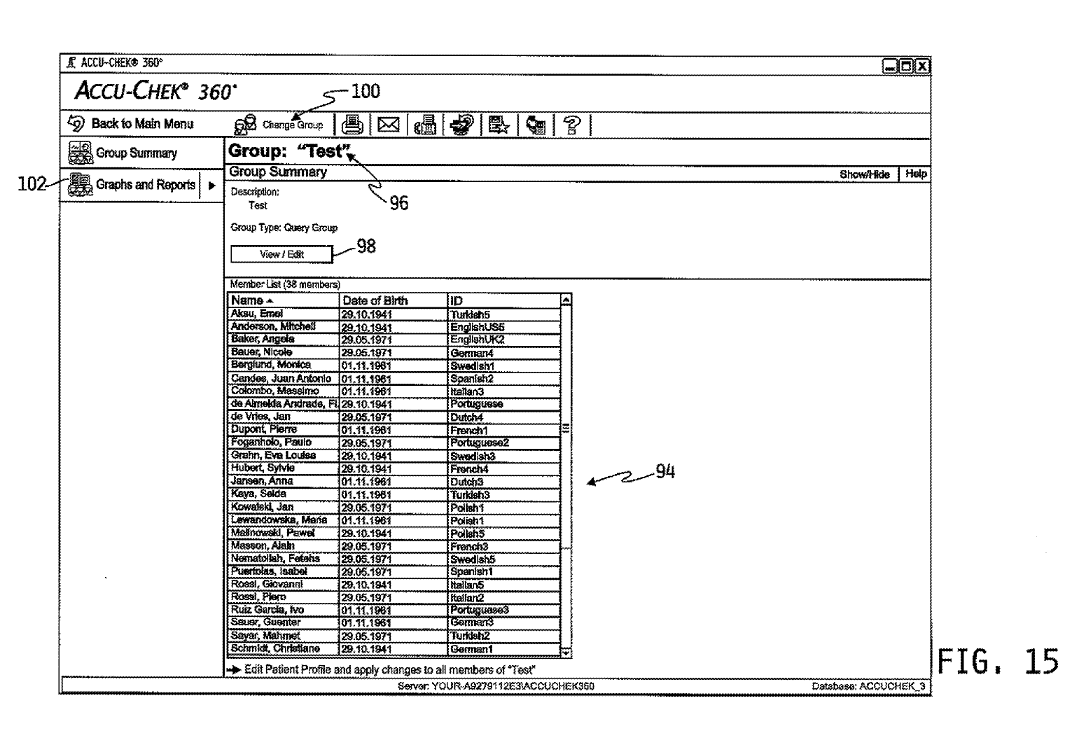

FIG. 15 depicts a screen capture illustrating the patients satisfying the search criteria set forth previously. Numeral 94 generally indicates the list of the patients satisfying the search criteria set forth above. The title of the group is set forth above the list 94 at 96. If the health care provider desires to edit the search criteria, the health care provider may actuate the View/Edit icon 98. In addition, by clicking the Change Group icon 100, the health care provider may change the group in order to select another group of patients discovered in previously saved searches as groups. By actuating the Graphs & Reports icon 102, the health care provider may display various reports and graphs relating to the health care of the patients comprising the current group. For example, the health care provider can plot blood glucose measurements versus time for the entire group of patients located during the searching described above.

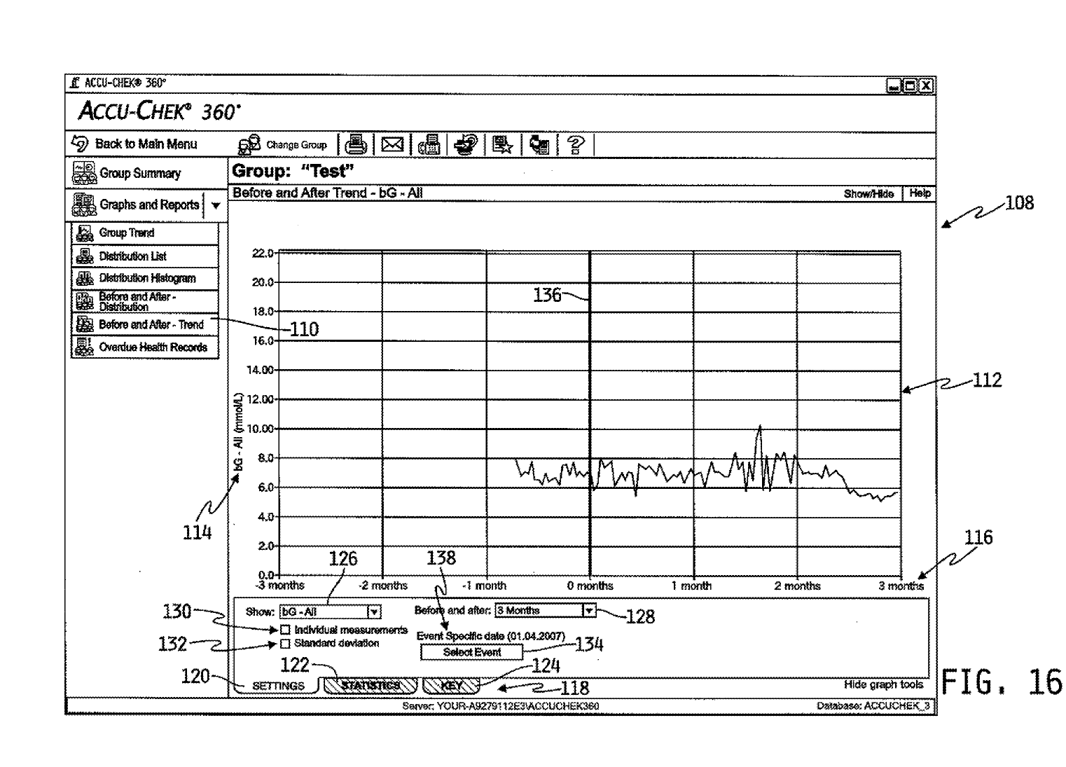

FIG. 16 depicts a screen capture illustrating a display area 108 after the Before and After—Trend icon 110 has been selected under the Graphs & Reports icon 102. Display area 108 includes a graph 112 displaying medical data from the Test group. In the depicted embodiment, graph 112 is a plot of the average blood glucose measurements of the patients comprising the Test group versus time. Accordingly, y-axis 114 includes ticks relating to the blood glucose measurements, and the x-axis 116 includes ticks relating to time. In the depicted embodiment of the invention, graph 112 displays the data as a single line representing an average of the data points and functioning as a trend line.

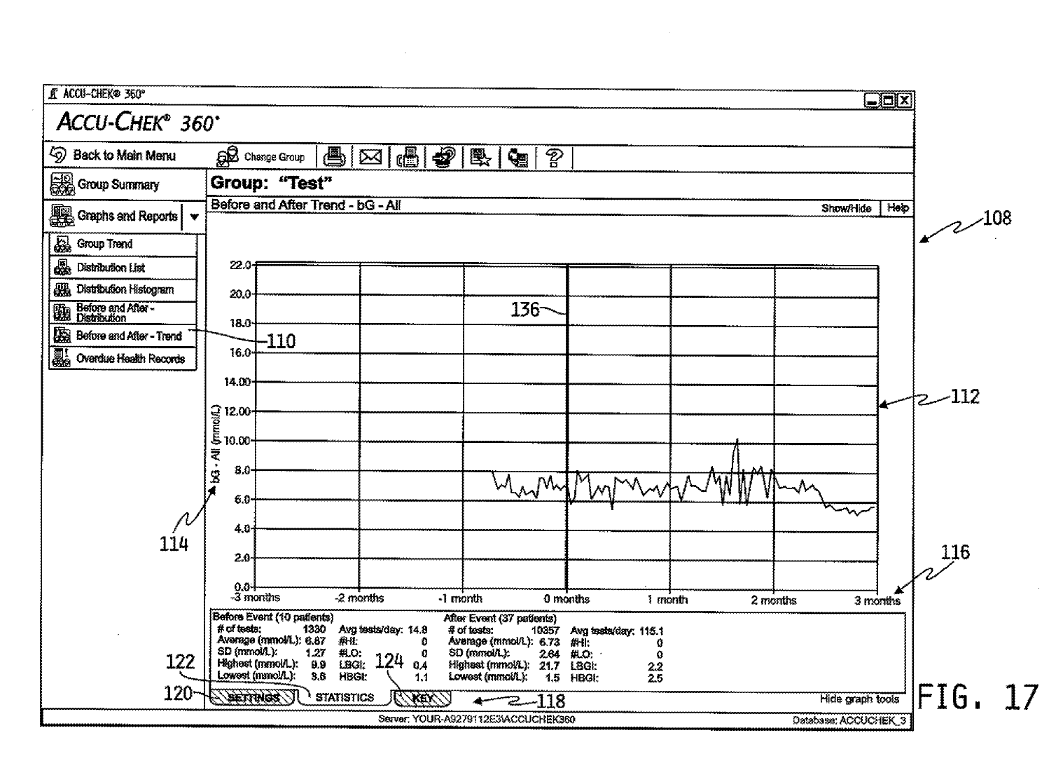

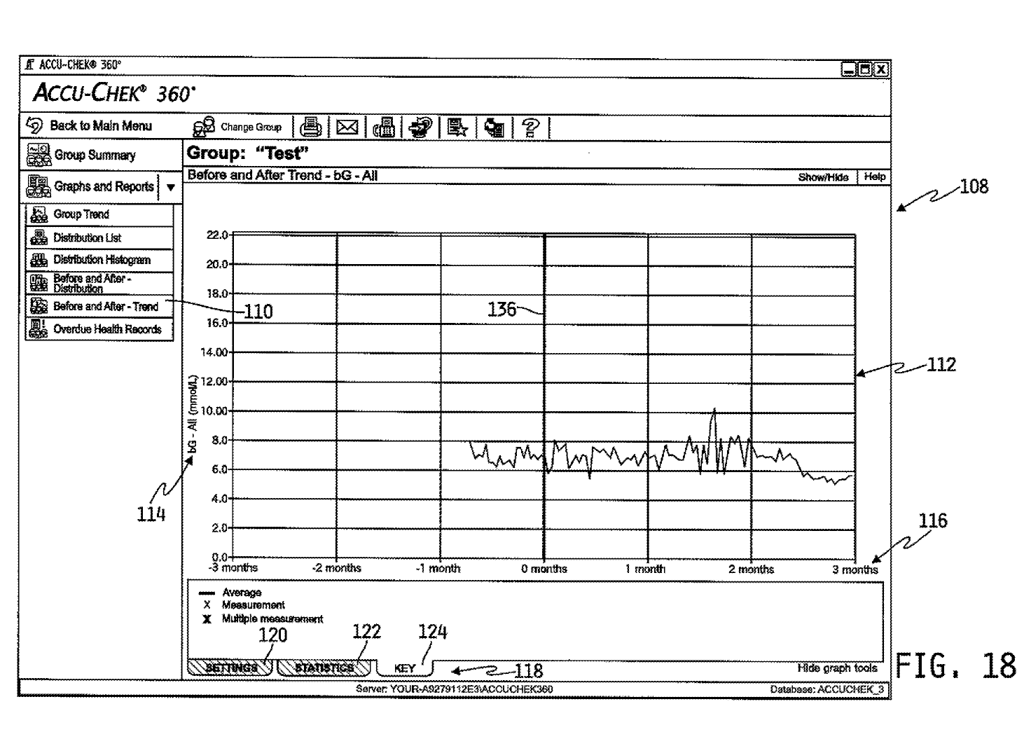

Referring still to FIG. 16, display area 108 includes a plurality of tabs generally indicated by numeral 118. Tabs 118 include a settings tab 120, a statistics tab 122 and a key tab 124. Settings tab 120 allows the health care provider to alter the settings of graph 112. As shown in FIG. 17, in the depicted embodiment, the actuation of the statistics tab 122 displays a variety statistical information associated with the data depicted on graph 112. The actuation of the key tab 124 displays a key for the marks present in graph 112, as shown in FIG. 18.

Referring again to FIG. 16, the settings tab 120 includes two drop down menus 126, 128, two toggle buttons 130, 132 and a select event icon 134. Drop down menu 126 defines the type of data measurements plotted on the y-axis 114, and a health care provider may utilize drop down menu 128 to select the time span covered by graph 112.

In the depicted example, as shown in drop down menu 126, blood glucose measurements are displayed on graph 112. With drop down menu 126, a health care provider may change the type of data depicted on the graph 112. For example, the provider may choose to graph insulin concentration, weight, or any other suitable medical data.

Referring still to FIG. 16, activating toggle switch 130 causes the individual measurements of the patients comprising the selected group to be plotted on the graph 112. Activating toggle switch 132 causes a shaded area representing the standard deviation of the measured data of the patients to be displayed on the graph 112.

The Select Event icon 134 may be used to select the event represented by line 136 in graph 112. Numeral 138 generally indicates the Selected Event represented by line 136. In the present example, the Selected Event 138 is a Specific Date, namely Apr. 1, 2007. Since drop down menu 128 sets a range of plus three months and minus three months, graph 112 plots blood glucose data from Jan. 1, 2007 through Jul. 31, 2007, with line 136 representing the data Apr. 1, 2007.

Drop down menu 128 may be used to change the span covered by the graph. For example, in the depicted embodiment, drop down menu 128 is set to three months. Accordingly, the data displayed on graph 112 is data collected plus and minus three months from a specific event. In graph 112, the specific event is represented by line 136. The time duration set forth in drop down menu 128 may be altered in any suitable manner. For example, the health care provider may click drop down menu 128 using a mouse and then select the desired time frame from the drop down menu 128.

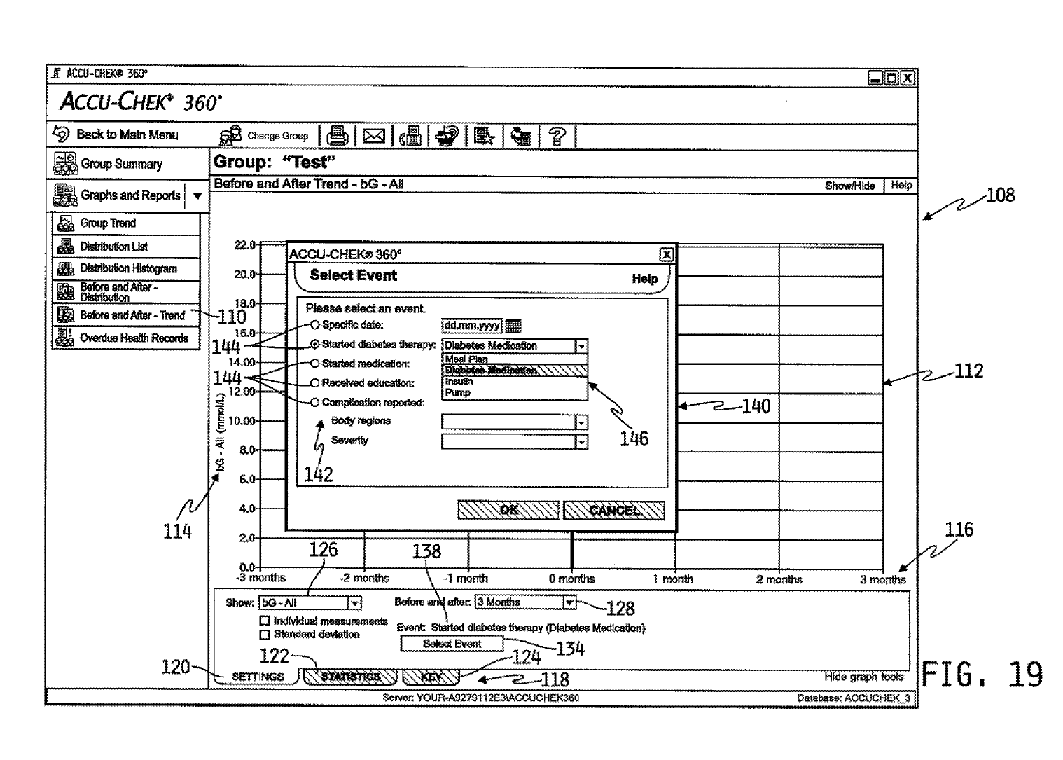

If the health care provider desires to change the Selected Event 138, the health care provider may actuate the select event icon 134. As shown in FIG. 19, actuation of the Select Event icon 134 causes a Select Event box, indicated by numeral 140, to be displayed. In the depicted embodiment, Select Event box 140 includes a plurality of event type toggles, generally indicated by numeral 142. Toggles 142 may include any suitable criteria representative of an event that a provider may want to track. For example, in the depicted embodiment toggles 142 includes events comprising “Specific data”, “Started diabetes therapy”, “Started medication”, “Received education,” etc. Each toggle 142 includes an indicator 144 capable of showing which toggle 142 is active. As shown in FIG. 19, the indicator 144 corresponding to the event “Started diabetes therapy” is active. Accordingly, the health care provider may select an event relating to the start of a diabetes therapy for the patients utilizing drop down menu 146, in any suitable manner. For example, the provider may select “meal plan,” “diabetes medication,” “insulin,” or “pump” as the type of therapy utilized by the patients. In this manner, a provider may determine the effect of a particular therapy on selected medical data, such as blood glucose level, of the group of patients.

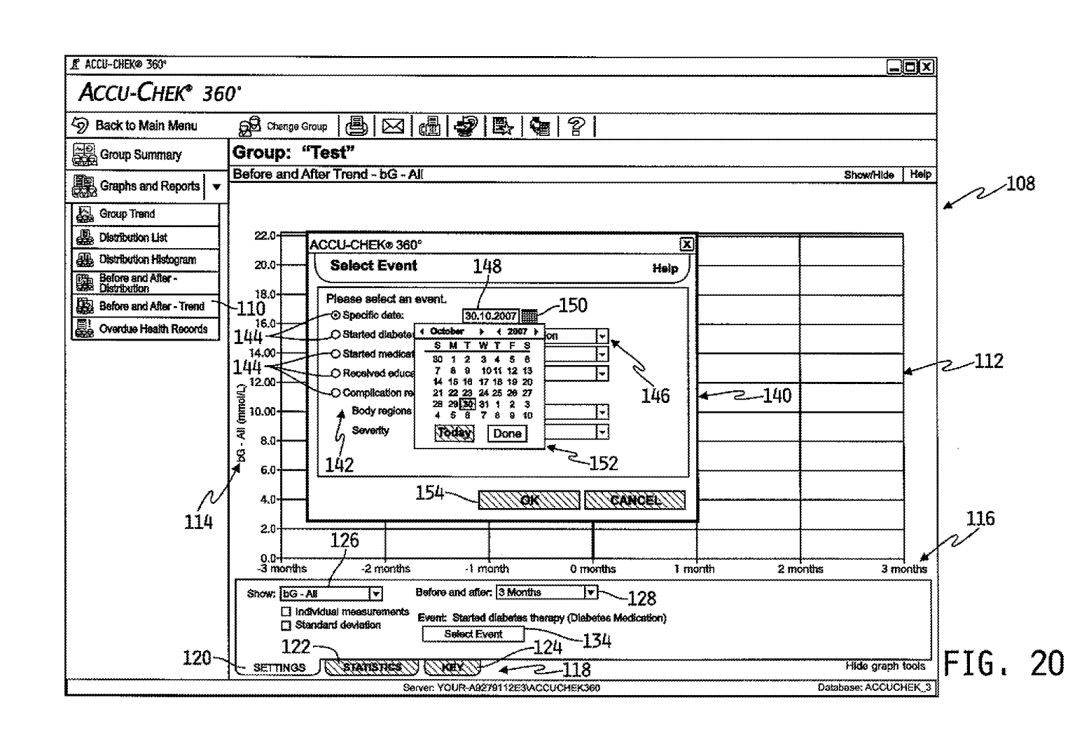

Referring to FIG. 20, if the health care provider desires to set the Selected Event to a date, the health care provider may manually enter the desired date in box 148. As an alternative, in the depicted embodiment, if the provider so desires, the provider may actuate icon 150 and display a calendar 152. Using calendar 152, the provider may select the desired date from the calendar. Once the provider has selected the desired event, the provider may close box 140 by actuating the OK icon 154. For purposes of the present example, the health care provider has determined the event is Apr. 15, 2007. It should be noted that indicator 144 for the “Specific Date” toggle has been turned on.

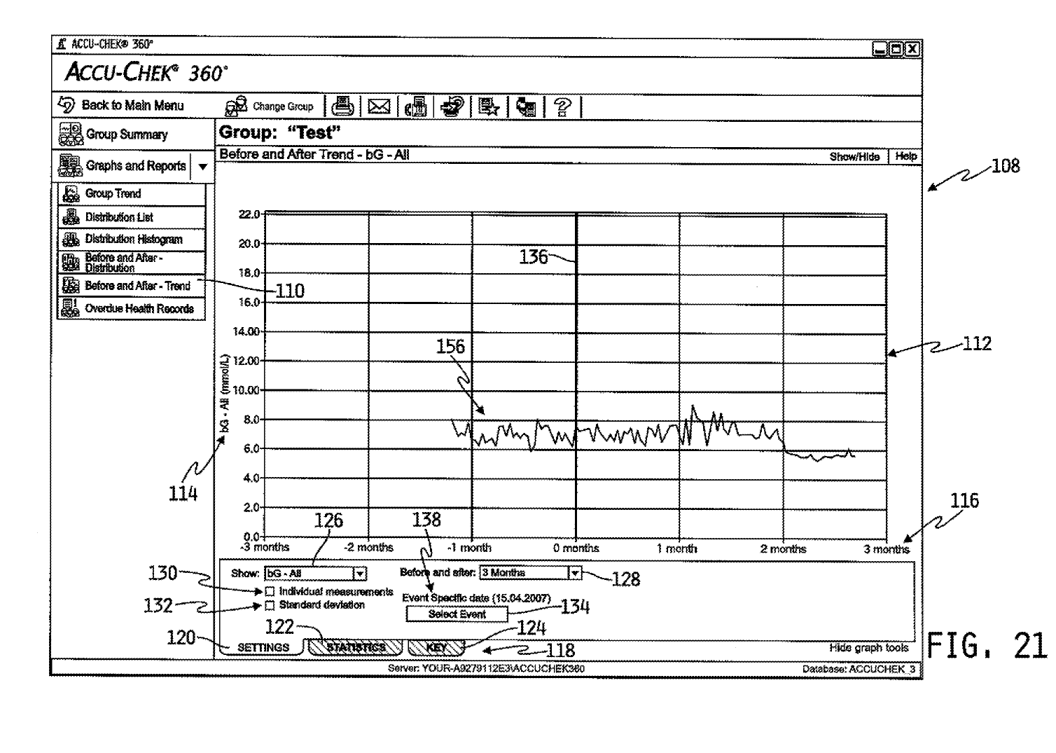

Referring now to FIG. 21, line 136 now represents the Selected Event, Apr. 15, 2007, as indicated at 138. Since drop down menu 128 is set to three months, the graph 112 displays the patient data plus and minus three months on either side of the Selected Event. Thus, in the present embodiment, the graph displays data from Jan. 15, 2007 through Jul. 15, 2007. As shown in FIG. 21, according to the depicted trend line, indicated by numeral 156, blood glucose data for the selected group of patients exists from approximately the first week of March until approximately the first of July.

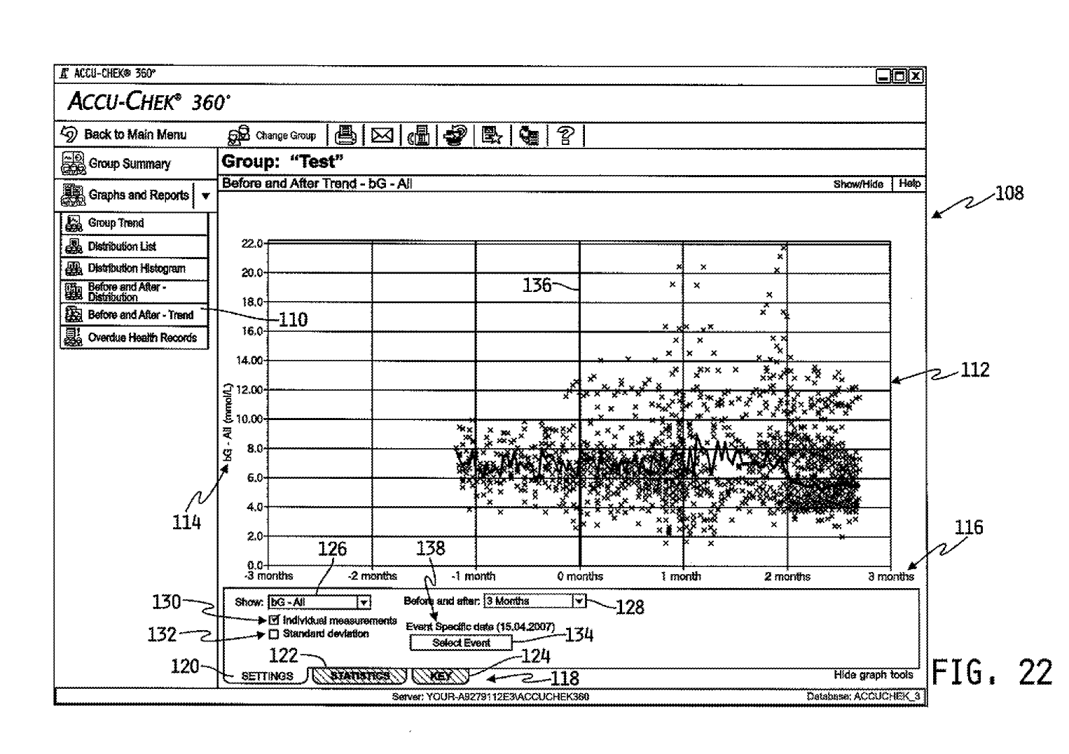

FIG. 22 depicts graph 112 with toggle 130 activated. Once toggle 130 has been activated, the individual data points for the patients are added to graph 112. It should be noted that no data points are located before or after the trend line 156.

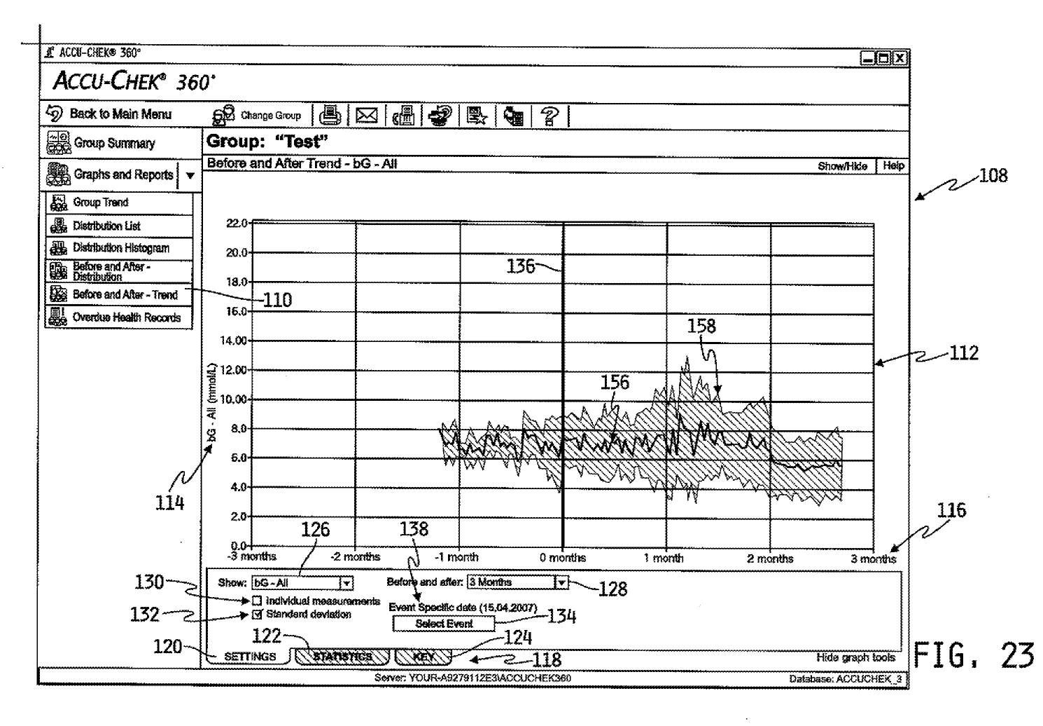

FIG. 23 depicts graph 112 with toggle 132 activated. As shown in FIG. 23, once toggle 132 is activated, a shaded area indicated by numeral 158 is overlaid on trend line 156. Shaded area 158 represents the standard deviation of the medical data displayed on graph 112.

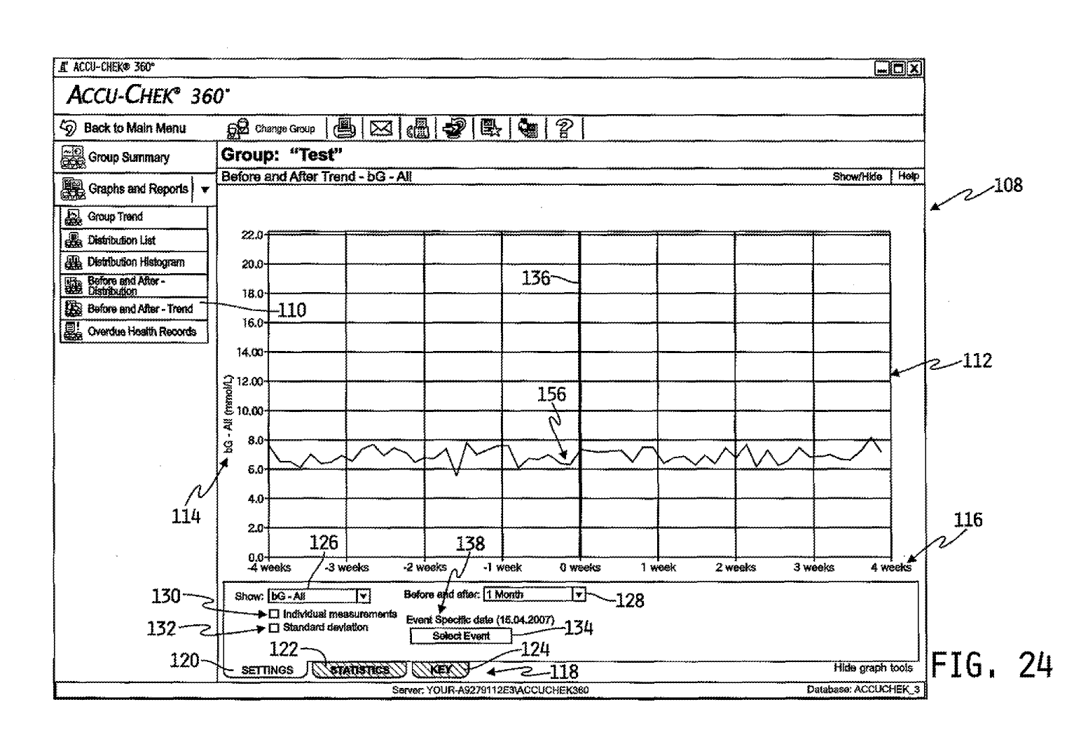

Referring again to FIG. 21, a health care provider may change the date range of data plotted on graph 112 using drop down menu 128. For example, if the provider desires to focus on data within one month of the Selected Event 138, in the depicted embodiment, the provider may click drop down menu 128 in order to provide different options as to the time span. For example, if the health care provider were to select a time span of “Before and after” of 1 month, the graph 112 would be configured as shown in FIG. 24. Specifically, only patient data recorded from one month prior (Mar. 15, 2007) to the Selected Event 138 (Apr. 15, 2007) to one month after (May 15, 2007) the Selected Event 138 is displayed on graph 112. In addition, it should be noted that x-axis 116 has been scaled in accordance with the selected date range. Accordingly, only the portion of trend line 156 that extends one month prior to the Selected Event line 136 and one month beyond line 136 is displayed in graph 112.

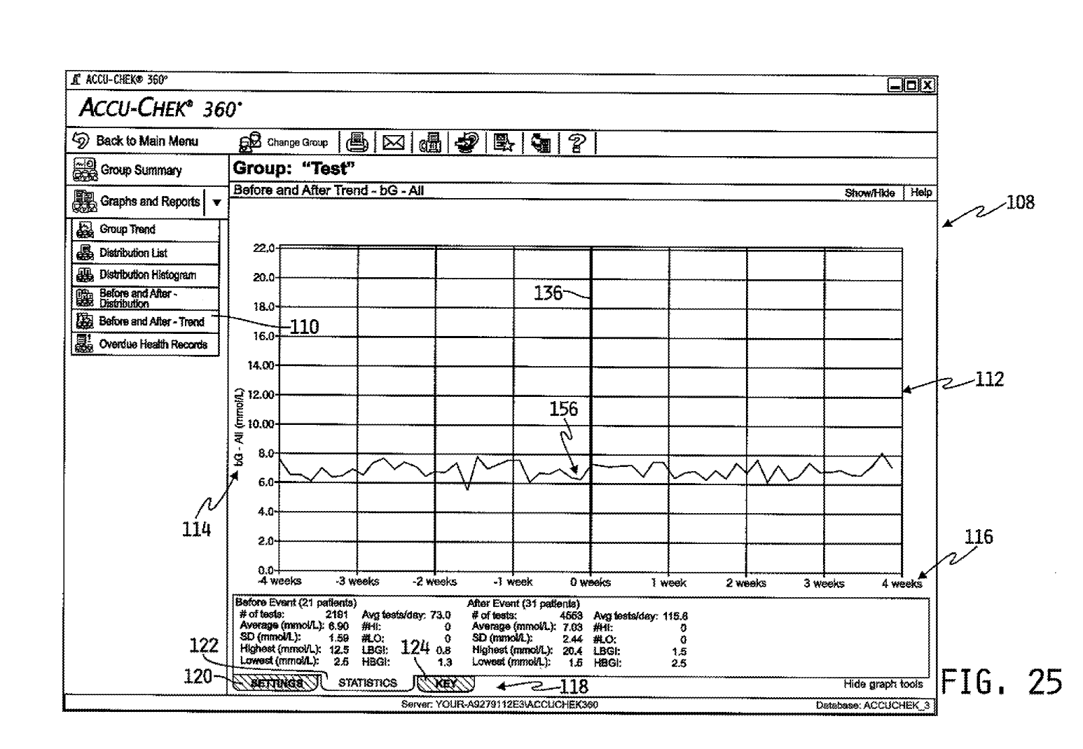

FIG. 25 depicts the display 108 after the statistics tab 122 has been selected. The statistics shown in tab 122 generally relate only to the data displayed on graph 112, rather than the entire population. Accordingly, a comparison of the statistical data present in FIG. 25 differs from the statistical data shown in FIG. 17.

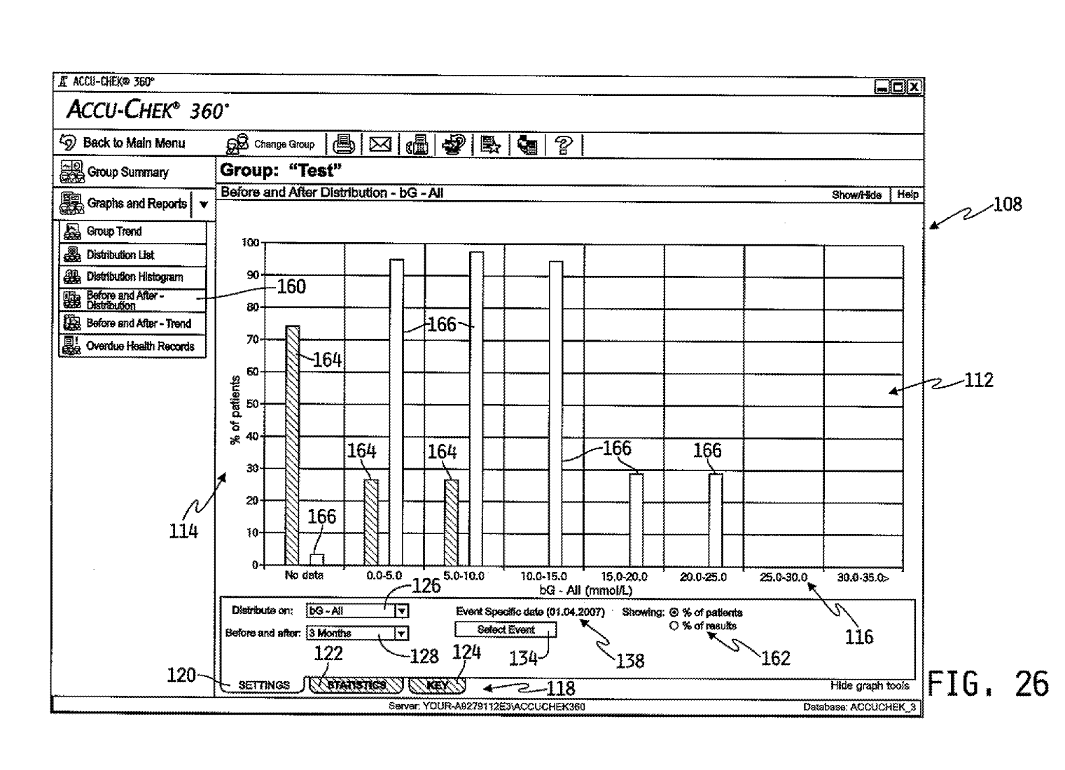

FIG. 26 depicts a histogram representation of the patient data that may be displayed after clicking Before and After—Distribution Icon 160. In FIG. 26, graph 112 includes tabs 118 comprising settings tab 120, statistics tab 122 and key tab 124. Settings tab 120 includes drop down menus 126, 128 and Select Event icon 134. Each of these components function in a manner identical to that described above.

In the depicted embodiment, graph 112 includes blood glucose measurements on the x-axis 116 and a percentage of patients on the y-axis 114. It should be noted that the data set forth on the x-axis 116 may be altered by selecting the distribution on drop down menu 126.

As shown in FIG. 26, in the depicted embodiment, the Selected Event 138 is a Specific Date of Apr. 1, 2007. Settings tab 120 further includes a percentage toggle indicated by numeral 162. Toggle 162 allows the health care provider to select whether the y-axis corresponds to the percentage of total patients or the percentage of total results reported. In the depicted embodiment, graph 112 includes lighter bars 164 and darker bars 166. The lighter bars 164 represent the data before the Selected Event 138, and the darker bars 166 represent the data recorded after the Selected Event 138. It should be noted that when the toggle 162 is set to percentage of patients, the data displayed on graph 112 shows the percentage of patients that have a blood glucose level within each distribution set. For example, as shown in FIG. 26, approximately 73 percent of the patients had no data prior to the event, but only approximately 3 percent of the patients had no data after the event. Similarly, approximately 25 percent of the patients had measurements between 0.0 and 5.0 mmmol/L prior to the event, and approximately 95 percent of the patients had measurements within this range after the event.

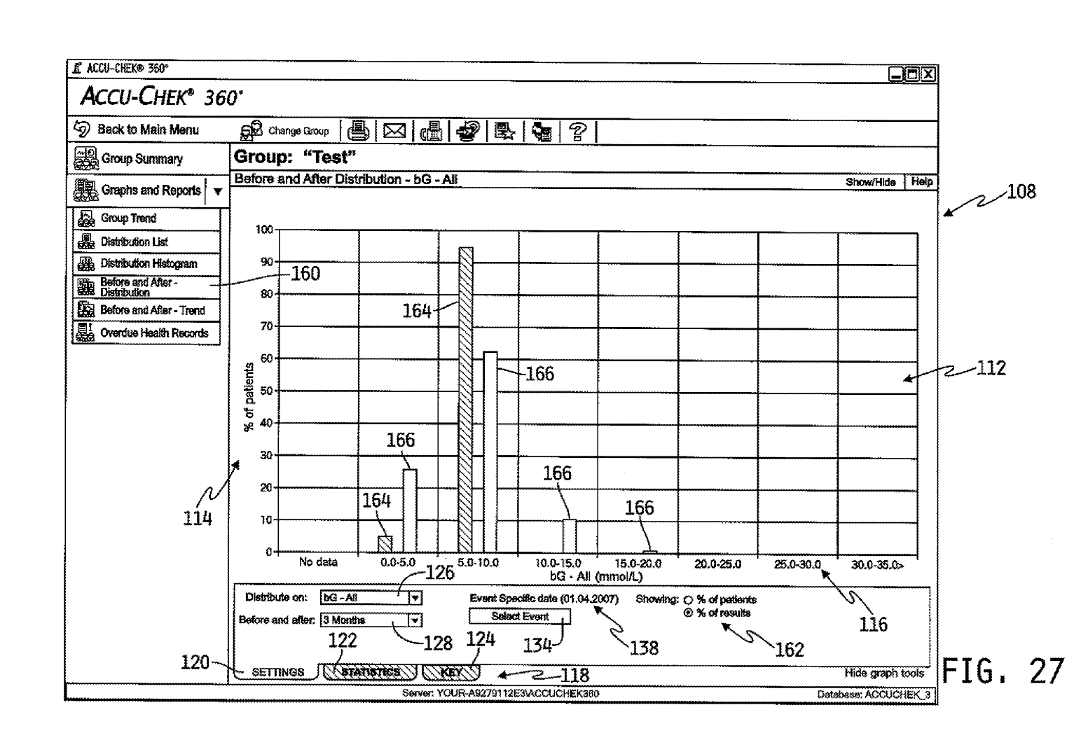

As shown in FIG. 27, toggle 162 is set to the percentage of results. Accordingly, the y-axis 114 has been altered to display the percentage of the results. The total percentage of the lighter bars 164 should be equal to 100 percent, and the total percentage of the darker bars 166 should be approximately equal to 100 percent. For example, with respect to the prior to event data, approximately 5 percent of the measured data falls between 0.0 and 5.0 mmmol/L, and approximately 95 percent of the measured prior to event data falls between 5.0 and 10.0 mmmol/L. The after event data, in the example shown, is spread across four different divisions on the x-axis 116. It should be noted that when the toggle 162 is set to percentage of results, there is no bar in the “no data” portion of the distribution.

Although the software is described herein for operation on a computer (e.g., desktop, laptop or tablet), it should be understood that the principles of the invention may be embodied in software for operation on various devices, including but not limited to personal digital assistants (“PDAs”), infusion pumps, blood glucose meters, cellular phones, or integrated devices including a glucose measurement engine and a PDA or cellular device.

The invention is described herein with reference to healthcare data management software, and more particularly, with reference to diabetes management software, although the invention may be applied, generally, to data management systems in fields unrelated to healthcare management.

While the invention is described herein with reference to medical devices, and more particularly, with reference to diabetes management devices, the invention is applicable to any data obtained from any device.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of presenting a set of data on a display including a graph, the method comprising the steps of:
selecting an event;
dividing the set of data into a first subset of data that occurred prior to the event and a second subset of data that occurred after the event;
plotting the first subset of data on the graph; and
plotting the second subset of data on the graph in a manner distinguishing the second subset of data from the first subset of data.

2. The method as set forth in claim 1 further comprising the step of plotting an event indicator on the graph between the first subset of data and the second subset of data.

3. The method as set forth in claim 2 wherein the indicator is a line.

4. The method as set forth in claim 1 wherein the first subset of data and the second subset of data are plotted as a trend line.

5. The method as set forth in claim 4 further comprising the step of plotting a standard deviation indicator on the graph.

6. The method as set forth in claim 5 wherein the standard deviation indicator is a shaded area.

7. The method as set forth in claim 1 further comprising the steps of:
dividing a second set of data into a first subset of second data and a second subset of second data;
plotting the first subset of second data on the graph; and
plotting the second subset of second data on the graph.

8. The method as set forth in claim 7 further comprising the step of removing the first subset of data from the graph.

9. The method as set forth in claim 1 wherein the first subset of data is plotted as a first subset of bars and the second subset of data is plotted as a second subset of bars.

10. The method as set forth in claim 9 wherein the first subset of bars are spaced apart from the second subset of bars.

11. The method as set forth in claim 9 wherein the first subset of bars are a first color and the second subset of bars are a second color and the first color differs from the second color.

12. The method as set forth in claim 9 wherein the data represents a percentage of patients.

13. The method as set forth in claim 9 wherein the data represents a percentage of results.

14. The method as set forth in claim 1 wherein the set of data comprises blood glucose measurements of at least one patient over time.

15. A method of plotting a set of data on a graph in order to determine if an event affected the health of a patient, the method comprising the steps of:
plotting the data on the graph; and
plotting an indicator representing the event on the graph.

16. The method as set forth in claim 15 wherein the indicator is a line.

17. The method as set forth in claim 15 further comprising the steps of:
selecting a finite period of time that includes the event; and
plotting the data on the graph that falls within the time period.

18. The method as set forth claim 15 further comprising the steps of:
selecting a second set of data; and
plotting the second set of data on the graph.

19. The method as set forth in claim 18 further comprising the step of removing the first set of data from the graph.

20. The method as set forth in claim 15 wherein the data is represented by a trend line.

21. The method as set forth in claim 15 wherein the data represents blood glucose measurements taken over time.

22. The method as set forth in claim 15 wherein the data represents insulin measurements taken over time.

23. A method of plotting a set of data on a histogram comprising the steps of:
selecting an event;
dividing the data into a first subset of data that occurred prior to the event and a second subset of data that occurred after the event;
displaying the first subset of data as at least one bar of a first type; and
displaying the second subset of data as at least one bar of a second type.

24. The method as set forth in claim 23 further comprising the steps of:
selecting a time period encompassing the event; and
limiting the data to a subset of data within the time period.

25. The method as set forth in claim 23 wherein the data represents a percentage of results.

26. The method as set forth in claim 23 wherein the data represents a percentage of patients.

27. The method as set forth in claim 23 wherein the first bar type is of a first color and the second bar type is of a second color.

28. The method as set forth in claim 23 wherein the data represents blood glucose data measured over time.

29. The method as set forth in claim 23 wherein the data represents insulin measurements taken over time.
